(19) United States
(12) Patent Application Publication
(10) Pub. No.: US 2018/0019977 A1
(43) Pub. Date: Jan. 18, 2018

(54) MULTI-LAYERED DATA SECURITY

(71) Applicant: SAP SE, Walldorf (DE)

(72) Inventor: RAVEESHKUMAR BHAT, Leimen (DE)

(21) Appl. No.: 15/210,894

(22) Filed: Jul. 15, 2016

(51) Int. Cl. H04L 29/06; H04L 9/08; H04L 9/06

(52) U.S. Cl. CPC H04L 63/0428; H04L 9/0643; H04L 9/0819

(57) ABSTRACT

Various embodiments of systems and methods for securing data to transmit between different software solutions are described herein. Data to be secured is identified at a data securing module. Hashing on the identified data is applied to generate a hash value. The identified data is encrypted to generate encrypted data of the identified data with an encryption key. Further, the hash value and the encrypted data are encoded by combining the hash key and the encryption key to generate encoded data. The encoded data is transmitted through a network.

### BACKGROUND

On-premise software solutions represent a model of software deployment where enterprises deploy applications in-house, e.g., within enterprise environment. On-demand solutions, such as software as a service (SaaS) or cloud computing are based on a model in which software and associated data pertaining to an application may be deployed and stored on remote facilities, e.g., cloud. Cloud storage is a model of networked online storage where data may be stored on multiple virtual servers.

Organizations may choose different applications to be implemented and executed in different software solution models. A part of an application maybe deployed in one software solution and another part of the application may be executed in another software solution, e.g., based on requirements of the application. Therefore, there can be situations where sensitive information may be communicated between an on-premise solution and an on-demand solution. Data protection during transmissions of sensitive data between different software solutions can be a challenge as there may be issues related to privacy and security.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 illustrates a computing environment to provide multi-layered data security, according to one embodiment.

FIG. 2 is a flow diagram illustrating a process to provide multi-layered data security, according to an embodiment.

FIG. 3 is a flow diagram illustrating a process to retrieve data form encoded data, according to an embodiment.

FIG. 4 is a block diagram of an exemplary computer system, according to an embodiment.

### DETAILED DESCRIPTION

Embodiments of techniques to provide multi-layered data security are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instance, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In this document, various methods, processes and procedures are detailed. Although particular steps may be described in a certain sequence, such sequence may be mainly for convenience and clarity. A particular step may be repeated more than once, may occur before or after other steps (even if those steps are otherwise described in another sequence), and may occur in parallel with other steps. Further, a step may be executed upon executing another step. Such a situation may be specifically pointed out when not clear from the context. A particular step may be omitted.

In this document, various computer-implemented methods, processes and procedures are described. It is to be understood that the various actions (identifying, receiving, storing, retrieving, and so on) may be performed by a hardware device (e.g., computing system), even if the action may be authorized, initiated or triggered by a user, or even if the hardware device is controlled by a computer program, software, firmware, and the like. Further, it is to be understood that the hardware device may be operating on data, even if the data may represent concepts or real-world objects, thus the explicit labeling as “data” as such may be omitted.

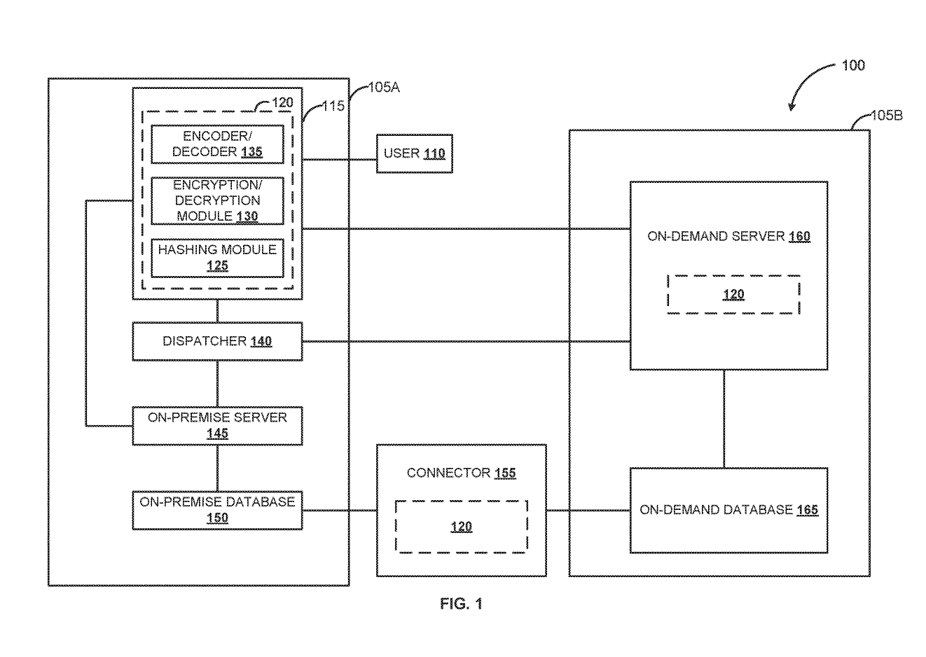

FIG. 1 illustrates computing environment 100 to provide multi-layered data security, according to one embodiment. The multi-layered data security is provided for secure data transmission between different software solutions (e.g., 105A and 105B). The computing environment 100 may include different software solutions (e.g., 105A and 105B) communicatively connected by a network (e.g., Internet). The software solutions can be one or more of on-premise solution 105A (e.g., executing an application by on-premise server 145 using data stored in on-premise database 150) and on-demand solution 105B (e.g., executing an application by on-demand server 160 using data stored in on-demand database 165). Organizations may choose to execute an application on the on-premise solution 105A or on the on-demand solution 105B. Also, the organizations may choose to execute a part of the application using a resource of the on-premise solution 105A and other part of the application using a resource of the on-demand solution 105B. For example, a business application may be deployed and/or run on the on-premise solution 105A (e.g., time and payroll information), and consume services or other resources provided by the on-demand solution 105B (e.g., public or virtual private cloud). Further, the business application may he deployed and/or run on the on-demand solution 105B and consume resources of the on-premise solution 105A.

The on-premise solution 105A is a computing platform, which may be installed and operated on the premises of an enterprise, for instance. On-premise solution 105A may deploy on-premise applications, which are executed on the on-premise server 145 using the on-premise database 150. The on-demand solution 105B may deploy on-demand applications. The on-demand solution 105B may he viewed as containing both a physical layer and an abstraction layer. The physical layer may consist of the hardware resources to support the cloud services being provided, and may include a server (e.g., the on-demand server 160), a storage unit (e.g., the on-demand database 165), network components, and the like. The abstraction layer may include software deployed across the physical layer, which manifests the essential functionalities provided by the on-demand applications. In various embodiments, the on-demand solution 105B may provide support for the application lifecycle process, for example, deployment, installation, provisioning and maintenance of applications. In one embodiment, the on-demand solution 105B may be a platform-as-a-service (PaaS) solution implemented in Java® technology. Example of such PaaS offering may be HANA® Cloud Platform provided by SAP® SE Company.

Connector 155 may establish a secure communication channel over a network between the on-premise solution 105A and the on-demand solution 105B. Once established, the secure communication channel may be used by the applications to remotely communicate with systems and resources of the on-premise solution 105A. in one embodiment, a persistent channel may also be used for bidirectional communication and by multiple virtual connections. Applications and systems of the on-premise solution 105A may use the communication channel to consume resources and services of the on-demand solution 105B.

In one exemplary embodiment, user 110 may access a page of the application through a graphical user interface on a user's computing device, such as, but not limited to a desktop computer and a smart phone. The GUI provides an interface for the user to interact with the computing device. The behavior of the GUI may be governed by computer executable instructions that are executed when the user interacts with the GUI. Further, the user 110 provides data for executing the application. The data can be sensitive data such as payroll information, personal information and the like, which may have to be secured before transmitting to a different software solution for further processing or storing, for instance. The data can be of different formats such as, but not limited to plain text, alphanumerical and numerical.

In one embodiment, data securing module (e.g., 120A, 1209 and 120C) acts as a security layer by identifying and securing the sensitive data. The sensitive data is secured by provided a multi-layered protection. Through multi-layered protection, sensitive data can be transmitted between different software solutions e.g., 105A and 105B) securely. The data securing module (e.g., 120A, 1209 and 120C) may, depending upon the implementation, be part of at least one of an application layer (e.g., 115) of the user interface associated with a user computing device, the on-demand server 160 and the connector 155. The application layer supports application and end-user processes, and considers user authentication and privacy, for instance. Further, the application layer may provide application services for file transfers, e-mail, and other network software services. For example, to secure the data transmitted to and from the on-demand solution, the data securing module 120A, 1209 and 120C) can be part of the on-demand server 160. In another example, when the secured data is stored in the on-demand database, the decrypting logic is implemented in the connector 155, which is responsible to convert the secured data and push the converted data to the on-premise database 150.

In one embodiment, the data securing module (e.g., 120A, 120B and 120C) includes hashing module 125, encryption/decryption module 130 and encoder/decoder 135. When the data is received, sensitive data or data to be secured is identified. Further, hashing is applied on the sensitive data to generate a hash value by the hashing module 125. The sensitive data is encrypted to generate encrypted data by the encryption/decryption module 130. The hash value and the encrypted data are combined to generate encoded data and the encoded data is securely transmitted. Therefore, the sensitive data is secured by the multi-layered protection (e.g., by applying hashing, encryption and encoding).

Further, the encoded data is transmitted from a first software solution to a second software solution via a secure communication channel between the first software solution unit and the second solution unit by a dispatcher (e.g., 140), for instance. The dispatcher 140 may act as a single point of access to the software solutions. The dispatcher 140 may be located between the Internet/Intranet and the software solutions. In one exemplary embodiment, the data securing module 120A, 120B and 120C) at the software solution, where secured data is received, can decode the secured data using the encoder/decoder 135. Further, decryption and hashing algorithm are applied to retrieve the sensitive data from the decoded data.

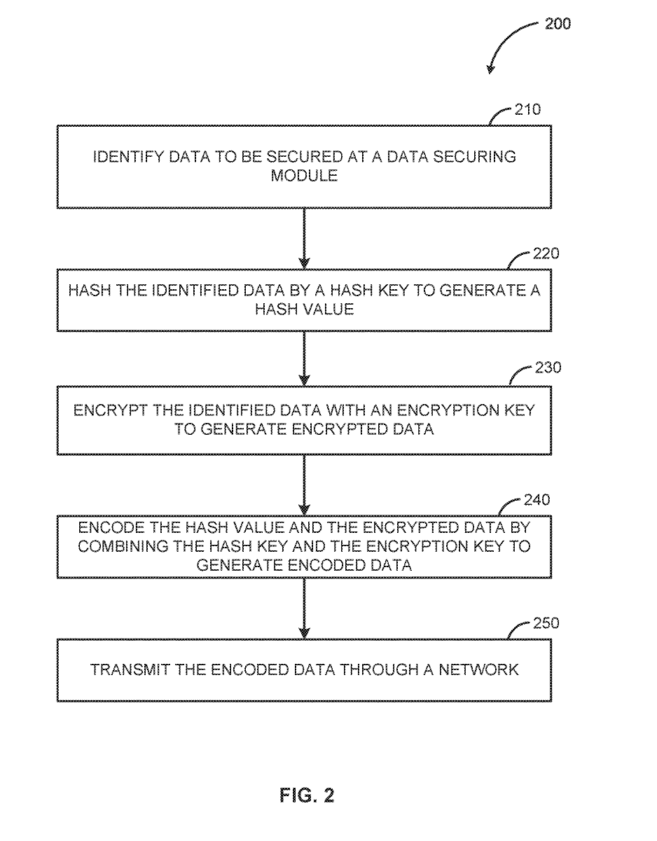

FIG. 2 is a flow diagram illustrating process 200 to provide multi-layered data security, according to an embodiment. At 210, data (e.g., sensitive data) to be secured is identified at a data securing module. In one exemplary embodiment, the data securing module can be implemented on at least one of an application layer of a user's computing device, a connector associated with different software solutions and an on-demand server of an on-demand solution.

In one exemplary embodiment, the data is associated with at least one of an on-premise application and an on-demand application. Further, the data may include sensitive data to be secured or protected from unauthorized access to safeguard the privacy or security of an individual or organization. The sensitive data can be, but not limited to personal information, organizational information and classified information. The personal information or personally identifiable information (PII) can be traced back to an individual, such as, but not limited to biometric data, medical information, personally identifiable financial information (PIFI) and unique identifiers such as passport or social security numbers. The organizational information may include information that poses a hazard to a company if discovered by a competitor or general public. Examples of organizational information include trade secrets, acquisition plans, financial data and supplier and customer information. The classified information pertains to a government body and is restricted according to level of sensitivity (for example, restricted, confidential, secret and top secret).

At 220, hashing on the identified data is applied to generate a hash value of the identified data with the hash key. Hashing can be defined as the transformation of a string of characters into a fixed-length value or key that represents the original string, for instance. The hashing algorithm can be referred as a hash function. The hash value returned by the hash function can be referred as hash codes, hash sums, and simply hashes. For example, Hashing can he one of cryptographic hash functions such as, but limited to secure hash algorithm (SHA) and Whirlpool secure hash function. For example, if “the quick brown fox jumps over the lazy dog” is identified as sensitive data, the hash value is “4F8F5CB531E3D49A61CF417CD133792CCFA501FD8DA53EE368FED20E5FE0248 C3A0B64F98A6533CEE1DA614C3A8DDEC791FF05FEE6D971D57C1348320F4EB42 D.”

At 230, the identified data is encrypted with an encryption key to generate encrypted data. Encryption can be defined as a method of processing data in such a way that authorized parties or users can read or access the encrypted data. In encryption, the intended sensitive data (e.g., plaintext) is encrypted using an encryption algorithm to generate ciphertext that can only be read if decrypted, for instance. Original data of the encrypted data can be obtained when the encryption key and an algorithm used for the encryption is known. The encryption can he one of an asymmetric public key encryption such as, but not limited to Rivest-Shamir-Adleman (RSA). The RSA is a cryposystem for public-key encryption. The RSA may be used for securing sensitive data, particularly when being sent over an insecure network such as the Internet. In one example, the public-key cryptography uses two different but mathematically linked keys, one public and one private. In RSA cryptography, both the public and the private keys can be used for encrypting the data and the opposite key from the one used to encrypt the data is used to decrypt the encrypted data.

At 240, the hash value and the encrypted data are encoded by combining the hash key and the encryption key to generate encoded data. In one example, the hash key and the encryption key is combined by a concatenate function. The concatenate function joins together a series of text strings or other values, into one combined text string. Encoding can be defined as transformation of data from one format into another format in such a way that it can be reversed without a key. Examples can be Uniform Resource Locator (URL) encoding, replaces unsafe American Standard Code for Information Interchange (ASCII) characters with a special character “%” followed by two hexadecimal digits; encoding Moving Picture Experts Group (MPEG-1) to Audio Video Interleave (AVI), and so on. For example, in ASCII, characters are encoded using numbers. Letter “A” is represented using number 65 and ‘B’ by number 66, for instance. These numbers can be referred to as the “code.” Similarly, encoding systems such as Double-Byte Character Set (DBCS), Extended Binary Coded Decimal Interchange Code (EBCDIC), Unicode and so on are also used to encode characters. Binary Coded Decimal (BCD) encoding system uses four bits to represent a decimal number and Manchester Phase Encoding (MPE) is used by Ethernet to encode bits.

At 250, the encoded data is transmitted through a network. For example, the encoded data at the application layer of the user computing device can be transmitted securely to the on-demand server. Therefore, the data securing module secures the sensitive data through multi-layered protection, where the hashing algorithm is applied to the sensitive data to generate the hash value and the encryption algorithm is applied to the sensitive data. Further, the hash value and the encrypted data are combined with the encoding algorithm to generate the final structure which is multi-secure.

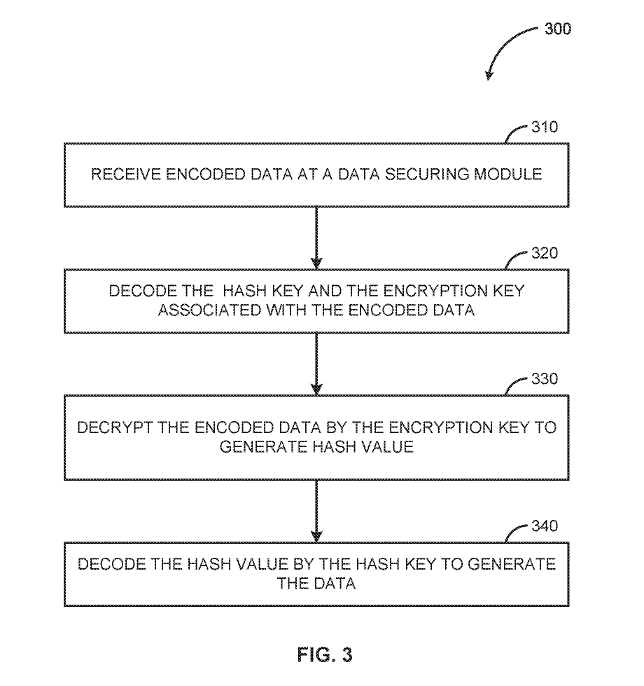

FIG. 3 is a flow diagram illustrating process 300 to retrieve data form encoded data, according to an embodiment. At 310, encoded data (e.g., encoded data at 240 of FIG. 2) is received at a data securing module. For example, the encoded data is received at the data securing module of the on-demand server. At 320, upon receiving the encoded data, a hash key and an encryption key associated with the encoded data are decoded. Further, the encoded data is decrypted by the encryption key to generate hash value, at 330. Decryption can be referred as a process of converting encrypted data to an original format using the encryption key so that a user can read and understand. At 340, the hash value is decoded by the hash key to generate the data, which was encoded. Therefore, the data securing module decodes the encoded data to retrieve the hash key and the encryption key. Once these keys are obtained, the data is decrypted by the encryption key to get the data containing the hash value. Further, the hash value is decoded to retrieve the sensitive data by the hash key. Thereby, the data securing module decodes the encoded data to restore sensitive data.

Some embodiments may include the above-described methods being written as one or more software components. These components, and the functionality associated with them, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may correspond to a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components arc tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

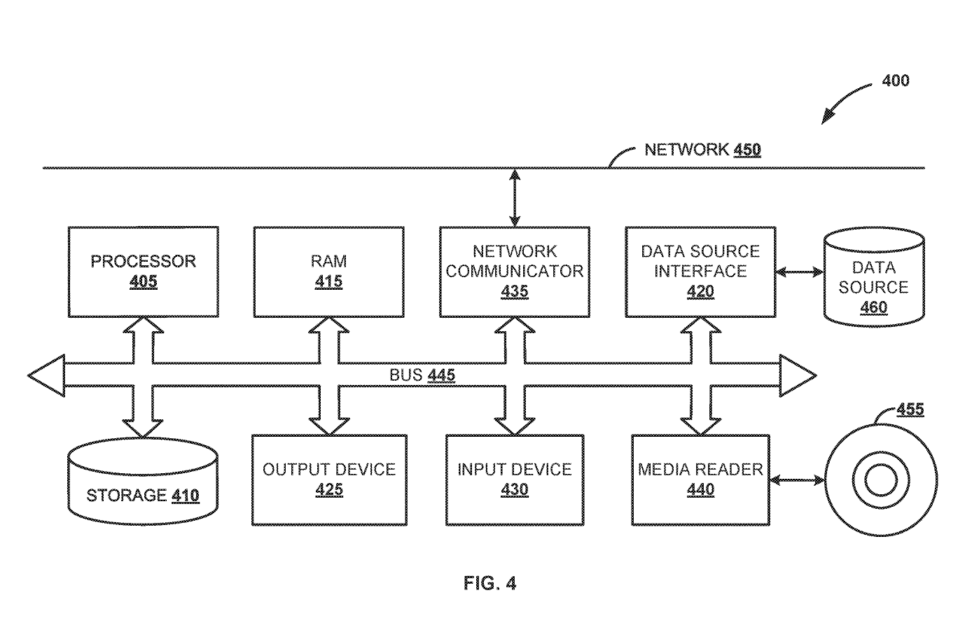

FIG. 4 is a block diagram of an exemplary computer system 400. The computer system 400 includes a processor 405 that executes software instructions or code stored on a computer readable storage medium 455 to perform the above-illustrated methods. The processor 405 can include a plurality of cores. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. According to some embodiments, such as sonic in-memory computing system embodiments, the RAM 415 can have sufficient storage capacity to store much of the data required for processing in the RAM 415 instead of in the storage 410. In some embodiments, the data required for processing may be stored in the RAM 415. The stored instructions may be further compiled to generate other representations of the instructions and dynamically stored in the RAM 415. The processor 405 reads instructions from the RAM 415 and performs actions as instructed. According to one embodiment, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In sonic embodiments the data source 460 may he accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on,

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as sonic steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiments are described herein for illustrative purposes, various equivalent modifications are possible within the scope of the embodiments, as those skilled in the relevant art will recognize. These modifications can be made in light of the above detailed description. Rather, the scope is to be determined by the following claims, which are to he interpreted in accordance with established doctrines of claim construction.

What is claimed is:

1. A non-transitory computer-readable medium storing instructions, which when executed by a computer cause the computer to perform operations comprising:
identifying, at a data securing module, data to be secured;
hashing the identified data by a hash key to generate a hash value;
encrypting the identified data with an encryption key to generate encrypted data;
encoding the hash value and the encrypted data by combining the hash key and the encryption key to generate encoded data; and
transmitting the encoded data through a network.

2. The non-transitory computer-readable medium of claim 1, wherein the data securing module resides in at least one of an application layer of a user computing device, a connector associated with different software solutions and a server of a software solution.

3. The non-transitory computer-readable medium of claim 2, wherein the software solution comprises one or more of an on-premise solution and an on-demand solution.

4. The non-transitory computer-readable medium of claim 1, wherein the data is associated with at least one of an on-premise application and an on-demand application.

5. The non-transitory computer-readable medium of claim 1, further comprising instructions, which when executed cause the computer to perform operations comprising:
receiving the encoded data at the data securing module;
decoding the hash key and the encryption key associated with the encoded data;
decrypting the encoded data by the encryption key to generate hash value; and
decoding the hash value by the hash key to generate the data.

6. The non-transitory computer-readable medium of claim 1, wherein the hash <ley and the encryption key are combined by a concatenate function.

7. The non-transitory computer-readable medium of claim 1, wherein the identified data is hashed by a cryptographic hash function.

8. A system to provide multi-layered data security, the system comprising:
a user computing device, wherein the user computing device comprises:
an application layer comprising a data securing module to:
identify data to be secured;
hash the identified data by a hash key to generate a hash value;
encrypt the identified data with an encryption key to generate encrypted data;
encode the hash value and the encrypted data by combining the hash key and the encryption key to generate encoded data; and
transmit the encoded data through a network.

9. The system of claim 8, wherein the data is associated with at least one of an on-premise application and an on-demand application.

10. The system of claim 8, wherein the encoded data is received by the data securing module residing in at least one of a connector associated with different software solutions and a server of a software solution.

11. The system of claim 10, wherein the software solution comprises one or more of an on-premise solution and an on-demand solution.

12. The system of claim 8, further comprising:
receiving the encoded data at the data securing module;
decoding the hash key and the encryption key associated with the encoded data;
decrypting the encoded data by the encryption key to generate hash value; and
decoding the hash value by the hash key to generate the data.

13. The system of claim 8, wherein e hash key and the encryption key are combined by a concatenation function.

14. The system of claim 8, wherein the identified data is hashed by a cryptographic hash function.

15. A computer implemented method to provide multi-layered data security, the method comprising:
identifying, at a data securing module, data to be secured;
hashing the identified data by a hash key to generate a hash value;
encrypting the identified data with an encryption key to generate encrypted data;
encoding the hash value and the encrypted data by combining the hash key and the encryption key to generate encoded data; and
transmitting the encoded data through a network.

16. The computer implemented method of claim 15, wherein the data securing module resides in at least one of an application layer of a user computing device, a connector associated with different software solutions and a server of a software solution.

17. The computer implemented method of claim 16, wherein the software solution comprises one or more of an on-premise solution and an on-demand solution.

18. The computer implemented method of claim 15, wherein the data is associated with at least one of an on-premise application and an on-demand application.

19. The computer implemented method of claim 15, further comprising:
receiving the encoded data at the data securing module;
decoding the hash key and the encryption key associated with the encoded data;
decrypting the encoded data by the encryption key to generate hash value; and
decoding the hash value by the hash key to generate the data.

20. The computer implemented method of claim 15, wherein the identified data is hashed by a cryptographic hash function.
